(19) United States
(12) Patent Application Publication
(10) Pub. No.: US 2018/0133107 A1
(43) Pub. Date: May 17, 2018

(54) PILL CRUSHER

(71) Applicant: Song YANG, Shanghai (CN)

(72) Inventor: Song YANG, Shanghai (CN)

(21) Appl. No.: 15/566,625

(22) PCT Filed: Apr. 15, 2015
(86) PCT No.: PCT/CN2015/076627

§ 371 Date: Oct. 13, 2017

(51) Int. Cl. A61J 7/00

(52) U.S. Cl. CPC A61J 7/0007

(57) ABSTRACT

A pill crusher comprises a base, a U-shaped movable crushing member, a first connecting rod, a handle, and a stopper. The U-shaped movable crushing member, the first connecting rod, the handle, and the stopper form a deformable four-connecting-rod structure. The U-shaped movable crushing member and the stopper form a V-shaped crushing cavity. As the handle is pressed downward, a space of the V-shaped crushing cavity is gradually closed. As the handle is lifted upward, the space of the V-shaped crushing cavity is gradually opened. The U-shaped movable crushing member can rub with respect to the stopper. The pill crusher pulverizes a pill in a highly efficient way, greatly buffers a reaction force in crushing a pill, reduces burden of users, and reduces potential wrist and elbow damage of medical staff caused by long term use.

### TECHNICAL FIELD

The disclosure relates to a medical device for assisting medicine administration, and more particularly to a pill crusher.

### BACKGROUND

Most oral medicines are taken by patients in the form of pills with different shapes and sizes. The so-called pills are produced into preparations in disc or anomalous shape by special forming process after uniform mixing of medicines and adjuvant materials, which are widely applied in the modern pharmaceutical industry, for having the advantages of accurate dosage, stable quality, convenience of carry and transport, and the like. In accordance with the requirements in various aspects such as the treatment, the dosage of a single pill and the proportion of raw materials to adjuvant materials, different pills have different requirements of the shape, the size and the like of the pills. For instance, vitamin pills, calcium pills and the like are usually larger, which are inconvenient for ordinary people to take one or more once, particularly for those special patents, such as the aged, children, postoperative patients, dysphagia patients or coma patients, who have difficulty in directly taking the pills, and thereby limiting the use of oral medicines and even affecting the treatment of patients.

Therefore, a device capable of crushing appropriate pills into pieces or powder is required, in order to assist the patients who need but cannot normally take standard preparations to take medicines for deserved treatment. The pill crusher should be safe, high efficient, low cost, quiet, labor-saving and easy to use and can avoid the cross-contamination of medicines. However, the traditional pill crushers, generally employ the means of simple shock and grinding or employ a single lever to realize the action of crushing pills, e.g., “pot for pounding pills”, which have the defect of low efficiency, loud noise, labor-consuming, quantity loss or the cross-contamination of pills and the like in the pill crushing process, and hence cannot fully meet the requirements of crushing the pills safely and efficiently. In particular, when pill crushers are used by medical personnel at medical institutions, the characteristics thereof such as the crushing speed, efficiency, quietness, exogenous contamination/cross-contamination avoidance, labor-saving level and the like are especially important.

In view of the above, the disclosure provides a pill crusher, which overcomes or decreases the above defects.

### SUMMARY

The objective of the disclosure is to provide a pill crusher, which overcomes the defects in the prior art, and more fully meets the requirements of crushing pills safely and efficiently such as safety, labor-saving, high efficiency, low noise, easy processing, low cost, convenient maintenance and cleaning, and capability of effectively preventing cross-contamination and the like.

In order to achieve the above objective, the disclosure provides a pill crusher, comprising:

a base;

a stopper, arranged on said base, said stopper provided with a long axle hole;

a U-shaped movable crushing member, sheathed outside said stopper, said U-shaped movable crushing member comprising a crushing plate located at a first side of said stopper and two side walls respectively connected with two sides of said crushing plate, said two side walls pivotally connected with the long axle hole of said stopper through a first rotating axle, said first rotating axle elastically supported on an upper end of said long axle hole, said U-shaped movable crushing member capable of pivoting with respect to said stopper to form a V-shaped crushing cavity capable of being closed by pressing or being opened between said crushing plate and said stopper, and, as said first rotating axle moving from the upper end to a lower end inside said long axle hole, said U-shaped movable crushing member capable of rubbing downward with respect to said stopper;

a first connecting rod, located at a second side of said stopper, said first connecting rod having a first end pivotally connected with said stopper, and a second end;

a handle, having a first end pivotally connected with the second end of said first connecting rod, and a pivoting portion pivotally connected with said two side walls of said U-shaped movable crushing member;

said U-shaped movable crushing member, said first connecting rod, said handle, and said stopper collectively form a deformable four-connecting-rod structure having four rotating axles, as said handle is pressed downward, an angle between said first connecting rod and said handle is increased, and a space of said V-shaped crushing cavity is gradually closed; as said handle is lifted upward, the angle between said first connecting rod and said handle is decreased, and the space of said V-shaped crushing cavity is gradually opened.

Preferably, the pill crusher further comprises a second connecting rod, having a first end pivotally connected with said first rotating axle, and a second end pivotally connected with said stopper, and a spring is arranged between said second connecting rod and said base, said spring jacks up said first rotating axle through said second connecting rod to elastically jack up said first rotating axle to the upper end of said long axle hole.

Preferably, said long axle hole is an elliptic axle hole, a long axis of said ellipse is perpendicular to said base.

Preferably, said long axle hole is an oblique elliptic axle hole, an upper end of said ellipse is closer to said crushing plate than a lower end of said ellipse.

Preferably, the pill crusher further comprises a spring arranged between said first rotating axle and said base, said spring jacks up said first rotating axle to the upper end of said long axle hole.

Preferably, as said handle is lifted upward, a cross section of said four-connecting-rod structure is an inverted quadrangle; as said handle is pressed downward, said first connecting rod and said handle tend to be a straight line, the cross section of said four-connecting-rod structure is gradually deformed into a triangle.

Preferably, when rotation between said first connecting rod and said handle is hindered, said U-shaped movable crushing member and said handle form an integrated L-shaped rotating rod.

Preferably, said stopper is a U-shaped fixed stopper fixed on said base, and comprises a stop plate arranged with respect to said crushing plate and two side walls respectively connected with two sides of said stop plate;

upper portions of the side walls of said U-shaped fixed stopper are pivotally connected with the first end of said first connecting rod through a second rotating axle;

the second end of said first connecting rod is pivotally connected with the first end of said handle through a third rotating axle; and

upper portions of the side walls of said U-shaped movable crushing member are pivotally connected with the pivoting portion of said handle through a fourth rotating axle.

Preferably, the two side walls of said U-shaped movable crushing member are sheathed outside the two side walls of said stopper;

the two side walls of said stopper are sheathed outside said first connecting rod and said second connecting rod;

said first connecting rod at least comprises a pair of pivoting lugs located respectively at two sides of the first end of said handle.

Preferably, the pill crusher further comprises a pair of first locating spacers;

said first locating spacers are sheathed outside two ends of said fourth rotating axle and are supported respectively between two sides of said handle and the two side walls of said U-shaped movable crushing member.

Preferably, the pill crusher further comprises a pair of second locating spacers;

said second locating spacers are sheathed outside the ends of said second rotating axle and are supported respectively between the two sides of said first connecting rod and the two side walls of said stopper.

Preferably, opposite sides of said crushing plate and said stop plate are respectively provided with any kind of anti-slip stripes, anti-slip patterns, engaged raised stripes, and engaged raised patterns.

Preferably, opposite sides of said crushing plate and said stop plate are respectively provided with horizontal raised stripes which can be engaged with each other.

Preferably, said stop plate of said stopper is perpendicular to said base.

Preferably, said base is provided with a stop post for limiting a pressing-down distance of said handle.

Preferably, the pill crusher further comprises an upper cover detachably mounted on said base, and a pill crusher pouch dispenser arranged between said upper cover and said base.

Preferably, said upper cover partially covers said stopper and said U-shaped movable crushing member, and is provided with an opening for said handle to extend outwards.

Preferably, the side walls of said U-shaped movable crushing member are inverted L-shaped.

Preferably, said side walls of said stopper are respectively L-shaped.

In order to achieve the above objective, the disclosure further provides a pill crusher, comprising:

a base, provided with a pair of long axle holes;

a stop plate, fixed on said base;

a movable crushing plate, a lower end of said movable crushing plate pivotally connected with the long axle holes of said base through a first rotating axle, said first rotating axle elastically pressed on lower ends of said long axle holes, said movable crushing plate capable of pivoting with respect to said stop plate to form a V-shaped crushing cavity capable of being closed by pressing or being opened between said movable crushing plate and said stop plate, and, as said first rotating axle moving from the lower ends to upper ends inside said long axle holes, said movable crushing plate capable of rubbing upward with respect to said stop plate;

a handle, having a first end pivotally connected with an upper end of said movable crushing plate, a second end, and a pivoting portion located between said first end and said second end;

a first connecting rod, a first end thereof pivotally connected with the pivoting portion of said handle, said first connecting rod capable of pivoting around a second end thereof;

said base, said movable crushing plate, said handle, and said first connecting rod form a deformable four-connecting-rod structure having four rotating axles, as said handle is pressed downward, an angle between said movable crushing plate and said handle is decreased, and a space of said V-shaped crushing cavity is gradually closed; as said handle is lifted upward, the angle between said movable crushing plate and said handle is increased, and the space of said V-shaped crushing cavity is gradually opened.

Preferably, the pill crusher further comprises a second connecting rod, having a first end pivotally connected with said first rotating axle, and a second end pivotally connected with said base, and a tension spring is arranged between said second connecting rod and said base, said tension spring tenses said first rotating axle through said second connecting rod to elastically press said first rotating axle to the lower ends of said long axle holes.

Preferably, a pivot portion is arranged on an upper portion of said second connecting rod, as said handle is pressed downward, said first connecting rod touches said pivot portion, overcomes tension of said tension spring, uplifts the first end of said second connecting rod, and drives said movable crushing plate to rub upward with respect to said stop plate.

Preferably, a distance between said pivot portion and the second end of said second connecting rod is less than a distance between said pivot portion and the first end of said second connecting rod, as said pivot portion is pressed downward by said first connecting rod, the first end of said second connecting rod is uplifted.

Preferably, said long axle holes are elliptic axle holes, long axes of said ellipses are perpendicular to said base.

Preferably, said long axle holes are oblique elliptic axle holes, upper ends of said ellipses are closer to said stop plate than lower ends of said ellipses.

Preferably, the pill crusher further comprises a tension spring arranged between said first rotating axle and said base, said tension spring presses said first rotating axle to lower ends of said long axle holes.

Preferably, said base is provided with a stop post for limiting a pressing-down distance of said handle, the second end of said first connecting rod is pivotally connected to said stop post.

Preferably, said stop post is provided with a pivoting hole, the second end of said first connecting rod is pivotally connected with said pivoting hole through a rotating axle, and an elastic sleeve is arranged between said rotating axle and said pivoting hole.

In order to achieve the above objective, the disclosure further provides a pill crusher, comprising:

a base;

a stopper, arranged on said base, said stopper or said base provided with a long axle hole;

a movable crushing plate, a connecting-rod structure connected between the movable crushing plate and a handle, and a pill crushing cavity capable of being opened or closed through the connecting-rod structure formed between said movable crushing plate and said stopper;

said movable crushing plate is elastically pivotally connected with said long axle hole through a first rotating axle, as said first rotating axle moves inside said long axle hole, said movable crushing plate is capable of rubbing along a surface of said movable crushing plate with respect to said stopper.

Preferably, said long axle hole is an elliptic axle hole, a long axis of said ellipse is perpendicular to said base.

Preferably, said long axle hole is an oblique elliptic axle hole, an upper end of said ellipse is closer to the surface of said movable crushing plate than a lower end of said ellipse.

Preferably, the pill crusher further comprises a spring elastically pressing said first rotating axle inside said long axle hole.

Preferably, said spring is arranged between said first rotating axle and said base.

Preferably, the pill crusher further comprises a second connecting rod, a first end thereof is pivotally connected with said first rotating axle, and a second end thereof is pivotally connected with said stopper or said base provided with said long axle hole, said second connecting rod is capable of pivoting around the second end thereof within a certain range.

As a result of using the above technologies, the pill crusher of the disclosure has special ways to crush pills through the V-shaped crushing cavity and the connecting-rod structure, which is good for users, particularly for users in medical institutions. The pill crusher of the disclosure has three different ways to crush pills, pulverizes medicines in a highly efficient way, greatly buffers the reaction force in crushing pills, reduces the burden of users, and particularly reduces potential wrist and elbow damage of medical personnel due to long-term use.

### BRIEF DESCRIPTION OF THE DRAWINGS

For the characteristics and advantages of the disclosure to be more obvious, detailed description about the technical schemes of the disclosure will be given below with reference to the accompanying drawings and the specific embodiments.

FIG. 1 is a perspective view of a pill crusher in a first embodiment;

FIG. 2 is an exploded view of the pill crusher in the first embodiment;

FIG. 3 is a state view illustrating the state when a handle is lifted before pill crushing of the pill crusher shown in FIG. 1;

FIG. 4 is a state view illustrating the state after the handle is pressed downward during the pill crushing of the pill crusher shown in FIG. 1;

FIG. 5 is an enlarged view of a stopper shown in FIG. 2;

FIG. 6 is an enlarged view of a U-shaped movable crushing member shown in FIG. 2;

FIG. 7 is an enlarged view of a first connecting rod shown in FIG. 2;

FIG. 8 is an enlarged view of the handle shown in FIG. 2;

FIG. 9 is an enlarged view of a second connecting rod shown in FIG. 2;

FIG. 10 is a side view of the stopper in the first embodiment;

FIG. 11 is a side view of another stopper;

FIG. 12 is a state view illustrating the state when the handle is lifted before the pill crushing of the pill crusher in the first embodiment;

FIG. 13 is a sectional view illustrating when the handle is lifted before the pill crushing of the pill crusher in the first embodiment;

FIG. 14 is a state schematic view illustrating a four-connecting-rod structure of the pill crusher shown in FIG. 13;

FIG. 15 is a state view illustrating the state when the handle begins to be pressed downward during the pill crushing of the pill crusher in the first embodiment;

FIG. 16 is a sectional view illustrating when the handle begins to be pressed downward during the pill crushing of the pill crusher in the first embodiment;

FIG. 17 is a schematic view illustrating the deformed state of the four-connecting-rod structure of the pill crusher shown in FIG. 15;

FIG. 18 is a state schematic view illustrating when the four-connecting-rod structure unable to continue deforming of the pill crusher shown in FIG. 16;

FIG. 19 is a state view illustrating the state when the pill crusher performing the pill crushing performed by pressure rubbing in the first embodiment;

FIG. 20 is a sectional view illustrating when the pill crusher performing the pill crushing performed by pressure rubbing in the first embodiment;

FIG. 21 is a schematic view illustrating the motion state of the U-shaped movable crushing member during the pill crushing performed by pressure rubbing of the pill crusher in the first embodiment;

FIG. 22 is a schematic view illustrating the motion state of the U-shaped movable crushing member and the first connecting rod during the pill crushing performed by pressure rubbing of the pill crusher in the first embodiment;

FIG. 23 is a state view illustrating the state after the pill crusher finishes the pill crushing in the first embodiment;

FIG. 24 is a sectional view illustrating the state after the pill crusher finishes the pill crushing in the first embodiment;

FIG. 25 is a schematic view of a pill crusher in a second embodiment; and

FIG. 26 is a sectional view of FIG. 25.

### DETAILED DESCRIPTION

Hereinafter, embodiments of the disclosure will be described in detail. While the disclosure will be described and illustrated with reference to certain specific embodiments, it is to be noted that the disclosure is not limited to these embodiments. Rather, modifications or equivalent substitutions of the disclosure are intended to be included within the scope of claims of the disclosure.

In addition, for the purpose of better illustrating the disclosure, numerous specific details are provided in the following detailed description. It will be understood by those skilled in the art that the disclosure may be practiced without these specific details. In other embodiments, well-known structures and components are not described in detail in order to highlight the gist of the disclosure.

The drawings of the disclosure are used only to indicate the relative positional relationship and the electrical connection relationship, the thickness of some parts is drawn by the exaggerated drawing method for easy understanding, so the length and width dimensions in the drawings do not represent the actual length and width dimensions. The upper, lower, left, right, horizontal, and vertical directions used in this article are non-restrictive expressions used to describe the relative direction with the drawings as a basis.

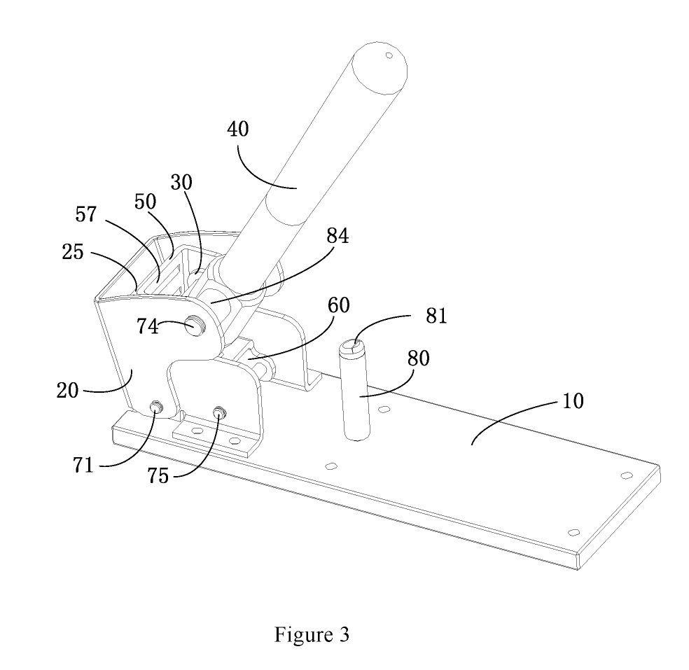

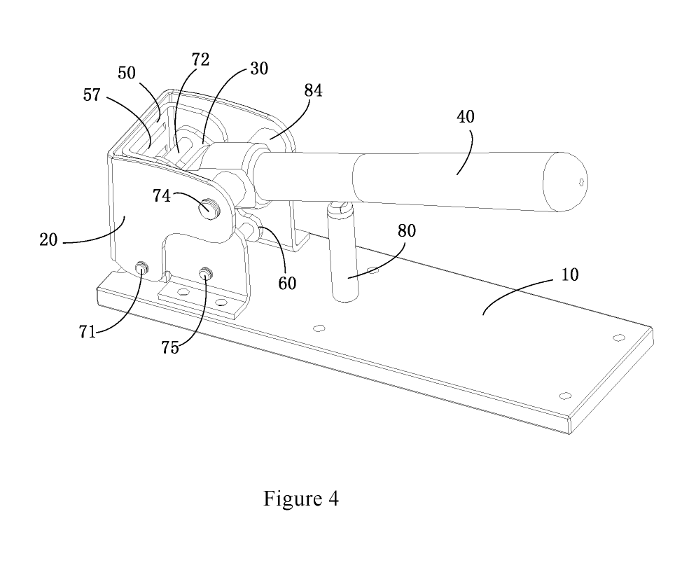

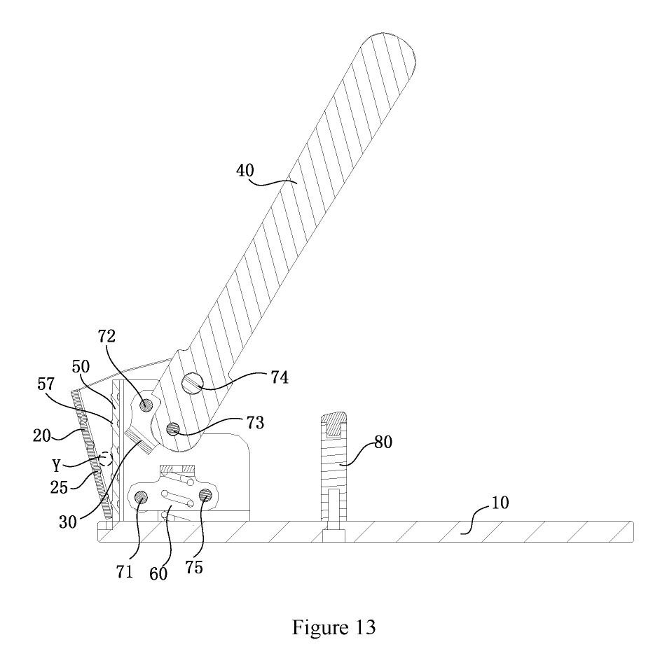

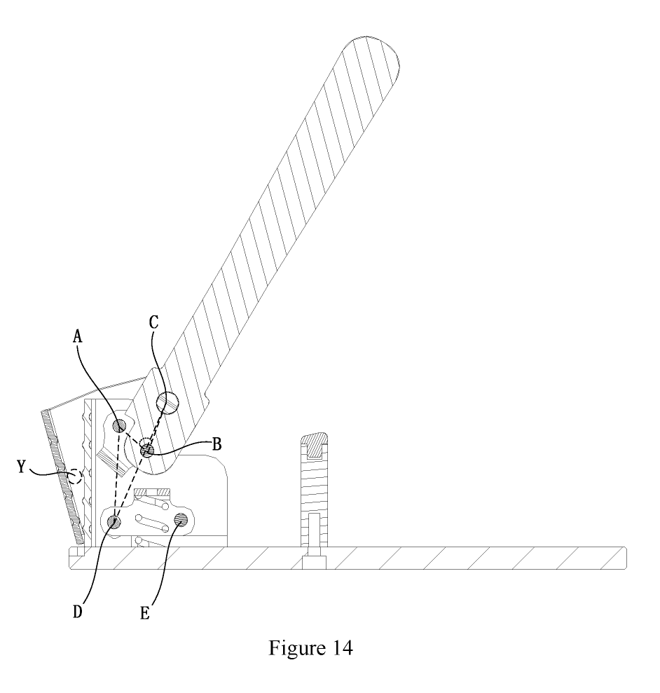

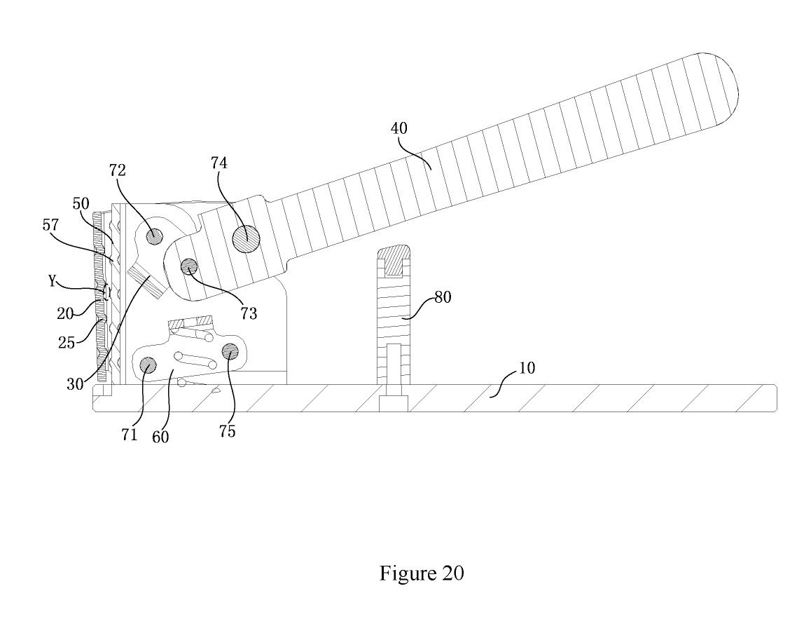

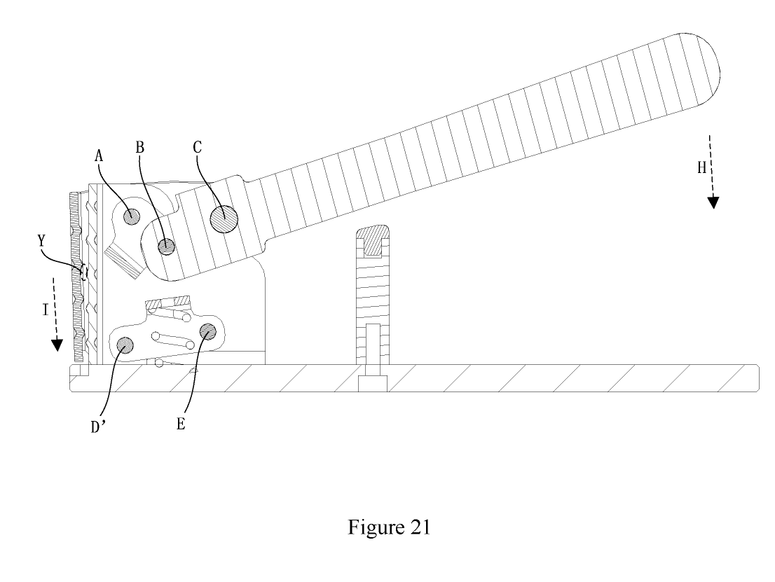

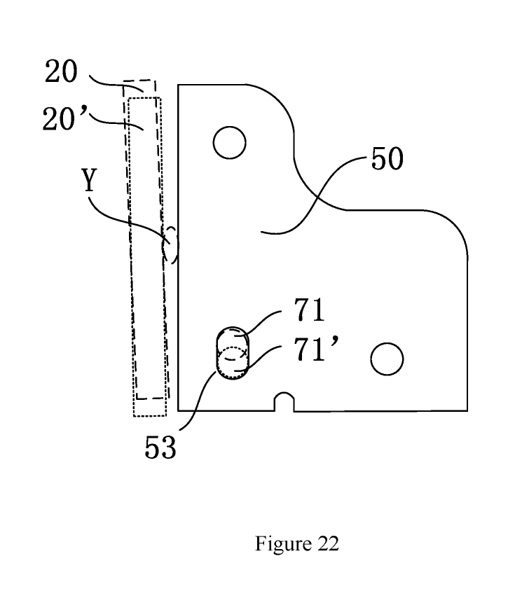

Further, in order to facilitate the viewing of the internal structure of the pill crusher, the upper cover and the pill crusher pouch dispenser are omitted in FIGS. 3 to 24.

### First Embodiment

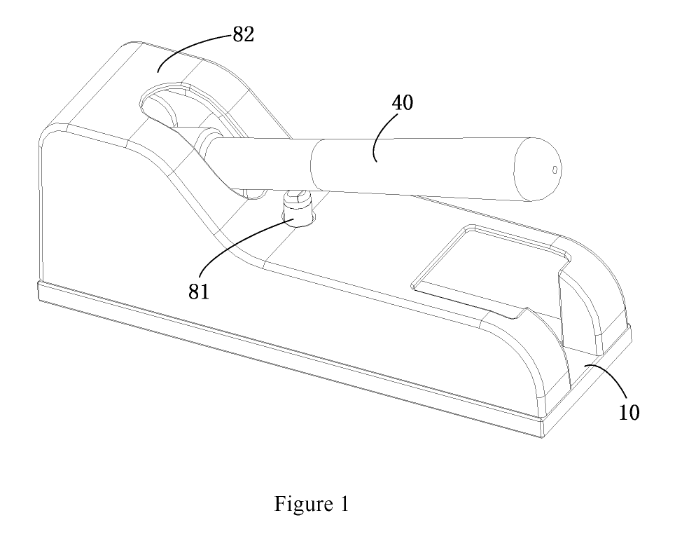

Please refer to FIGS. 1 to 4, the pill crusher in the first embodiment of the disclosure comprises a base 10, a U-shaped movable crushing member 20, a first connecting rod 30, a handle 40, a stopper 50, a second connecting rod 60, and an upper cover 82, wherein, the U-shaped movable crushing member 20, the first connecting rod 30, the handle 40, and the stopper 50 form a deformable four-connecting-rod structure having four rotating axles by mutually pivotally connecting with each other.

A stop post 80 for limiting the pressing-down distance of the handle 40 is arranged on the base 10. A rubber pad 81 is mounted on the top of the stop post 80. That is, under the resting state, the stop post 80 and the rubber pad 81 could support the handle 40 to be at a proper position for hand to hold the handle 40 conveniently. It is also possible to avoid the handle 40 pressing downward excessively and too much extrusion force between the U-shaped movable crushing member 20 and the U-shaped fixed stopper 11. In addition, the upper cover 82 is detachably mounted on the base 10, and a pill crusher pouch dispenser 83 for storing the pill crusher pouches is mounted between the upper cover 82 and the base. The upper cover 82 partially covers the stopper 50 and the U-shaped movable crushing member 20, and is provided with a first opening 821 for the handle 40 to extend outwards, a second opening 822 for the stop post 80 to pass through, and a third opening 823 for putting the pill crusher pouches in and taking it from the pill crusher pouch dispenser 83.

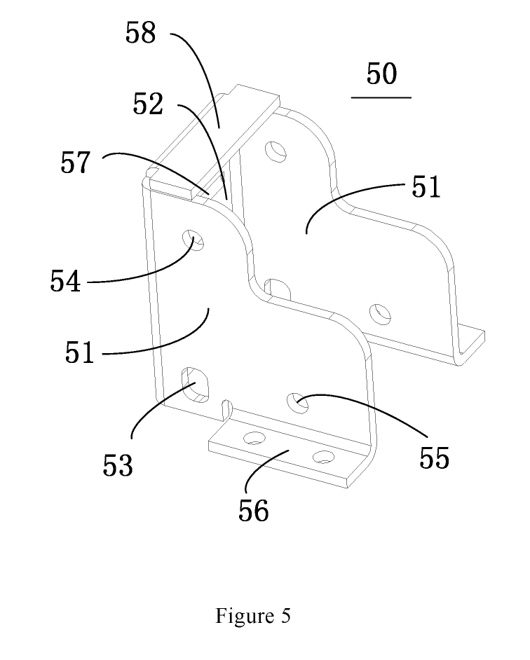

As shown in FIG. 5, the stopper 50 in the embodiment is a U-shaped fixed stopper arranged on the base 10 and including a stop plate 52 and side walls 51 connected with two sides of the stop plate 52. The side walls 51 are L-shaped. The form of the U-shaped fixed stopper 50 fixed on the base 10 may be as shown in the embodiment: bottoms of the side walls 51 extend outwardly to form two connecting plates 56 respectively, the connecting plates 56 are screwed to the base 10 respectively, but is not limited thereto. The two side walls 51 of the stopper 50 are sheathed outside the first connecting rod 30 and the second connecting rod 60. In the embodiment, the stop plate 52 is perpendicular to the base 10, but is not limited thereto.

One end of upper portions of the two side walls 51 near the stop plate 52 are provided with a pair of axle holes 54. A second end of lower portions of the two side walls 51 away from the stop plate 52 are provided with a pair of axle holes 55. And, a first end of lower portions of the two side walls 51 near the stop plate 52 are provided with a pair of long axle holes 53. In the embodiment, the length direction of the long axle holes 53 is substantially along the vertical direction.

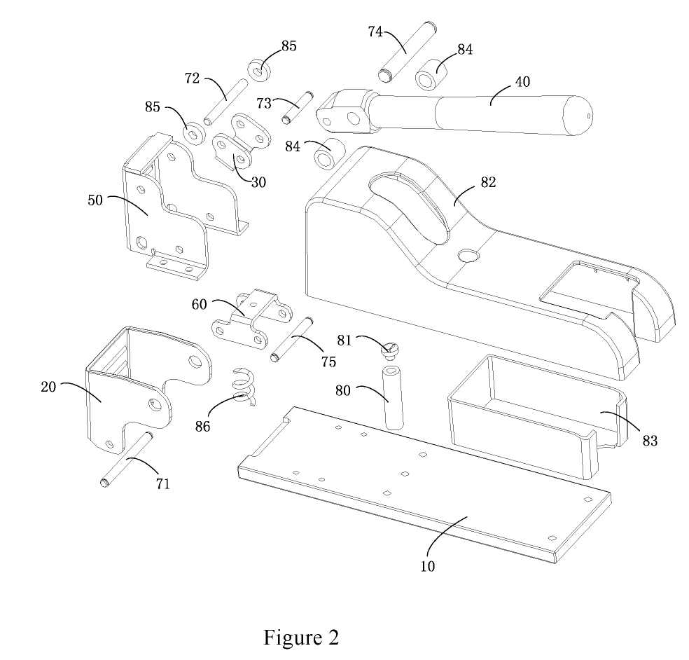

The stop plate 52 is provided with a plurality of second raised stripes 57 integrated formed in a horizontally spaced arrangement, but is not limited thereto. The stop plate 52 may also be provided with anti-slip stripes, anti-slip patterns, engaged raised stripes, engaged raised patterns and the like, in order to prevent the pills from slipping along the pressing area generated by the pressing action during the pill crushing, and further improve the efficiency and the effectiveness of the pill crushing. The top of the stop plate 52 is further extends with a top wall 58, two sides of the top wall 58 are connected with the two side walls 51. (The top wall is shown in FIG. 2 and FIG. 5, and is omitted in other figures in order to show the hidden internal structure)

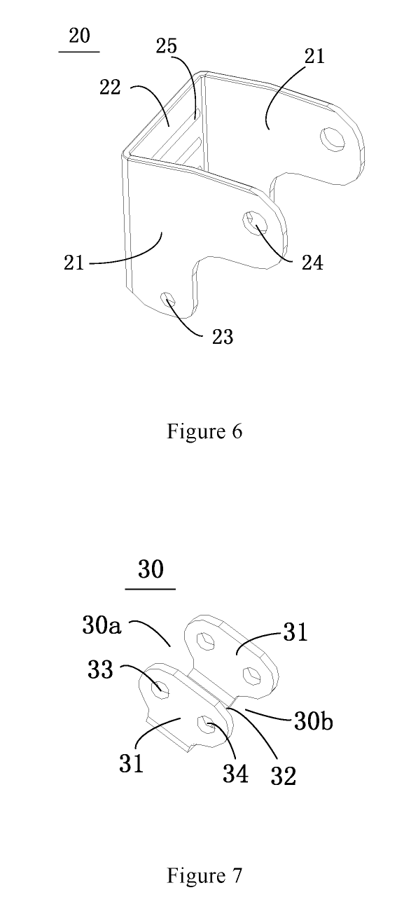

As shown in FIG. 6, the U-shaped movable crushing member 20 is sheathed outside the stopper 50, and includes a crushing plate 22 located at a first side of the U-shaped fixed stopper 50 and two side walls 21 respectively connected with two sides of the crushing plate 22. In the embodiment, the side walls 21 of the U-shaped movable crushing member 20 are inverted L-shaped, but the disclosure is not limited thereto. The two side walls 21 of the U-shaped movable crushing member 20 are sheathed outside the two side walls 51 of the stopper 50. One end of the upper portions of the two side walls 21 away from the crushing plate 22 are provided with a pair of axle holes 24. One end of the lower portions of the two side walls 21 near the crushing plate 22 are provided with a pair of axle holes 23.

The axle holes 23 on the two side walls 21 are pivotally connected to the long axle holes 53 of the U-shaped fixed stopper 50 through a first rotating axle 71, the first rotating axle 71 is elastically supported on upper ends of the long axle holes 53 (which will be described later), the U-shaped movable crushing member 20 pivots with respect to the U-shaped fixed stopper 50, to form a V-shaped crushing cavity capable of being closed by pressing or being opened between the crushing plate 22 and the U-shaped fixed stopper 50. That is, the U-shaped movable crushing member 20 is capable of pivoting around the first rotating axle 71 with respect to the U-shaped fixed stopper 50, and the V-shaped crushing cavity capable of crushing pill s is formed between the two.

Further, as the first rotating axle 71 is capable of moving up and down in the long axle holes 53, the U-shaped movable crushing member 20 is driven to move up and down. So the U-shaped movable crushing member 20 is capable of rubbing downward with respect to the stopper 50 as the first rotating axle 71 moves from the upper ends toward the lower ends in the long axle holes 53. As the pill is usually a dense sphere or ellipsoid, simple pressing cannot directly crush the pill, appropriate clamping and rubbing can quickly destroy the overall structure of the pill, thereby improving the effectiveness of the pill crushing.

The crushing plate 22 is provided with a plurality of first raised stripes 25 integrated formed in a horizontally spaced arrangement, the first raised stripes 25 on the crushing plate 22 could be engaged with the second raised stripes 57 on the stop plate 52, as the crushing plate 22 rubbing with respect to the stop plate 52, the pill is pressed in multi directions, but is not limited thereto. The crushing plate 22 may also be provided with anti-slip stripes, anti-slip patterns, engaged raised stripes, engaged raised patterns or raised points and the like, in order to prevent the pills from slipping along the pressing area generated by the pressing action during the pill crushing, and further improve the efficiency and the effectiveness of the pill crushing.

As shown in FIG. 7, the first connecting rod 30 is located at the second side of the stopper 50, and includes two side walls 31 and a connecting plate 32 connected with the two side walls 31. First ends 30a of the two side walls 31 are respectively provided with a pair of axle holes 33 to form a first pair of pivoting lugs; second ends 30b thereof are respectively provided with a pair of axle holes 34 to form a second pair of pivoting lugs. The first pair of pivoting lugs and the second pair of pivoting lugs may be on a same side wall as shown in FIG. 7 of the embodiment, or may be two pairs of pivoting lugs which are independent of each other. The axle holes 33 of the first pair of pivoting lugs of the first connecting rod 30 are pivotally connected to the axle holes 54 of the U-shaped fixed stopper 50 through the second rotating axle 72, so the first connecting rod 30 is capable of pivoting around the second rotating axle 72 with respect to the U-shaped fixed stopper 50. And, the second locating spacers 85 are sheathed outside the two ends of the second rotating axle 72, and are supported between the two sides of the first connecting rod 30 and the two side walls 51 of the stopper 50, respectively.

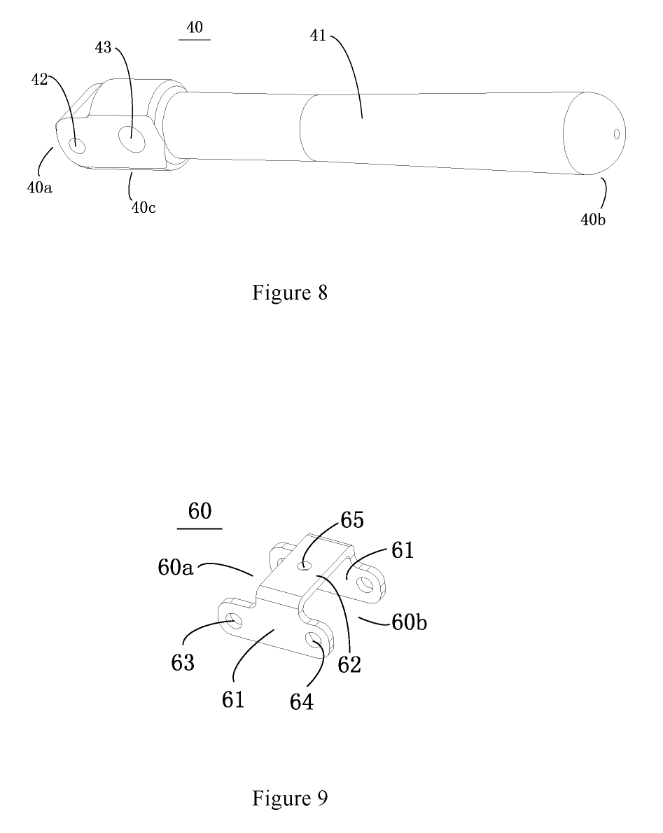

As shown in FIG. 8, the handle 40 includes a handle body 41 with a pivoting portion 40c, a first end 40a of the handle body 41 is located between the second pair of pivoting lugs of the first connecting rod 30, and is pivotally connected with the second end 30b of the first connecting rod 30; a second end 40b of the handle body 41 is held by users to be pressed downward; the pivoting portion 40c is pivotally connected with the two side walls 21 of the U-shaped movable crushing member 20. Wherein, the pivoting portion 40c is located between the first end 40a and the second end 40b and is near the first end 40a. The first end 40a of the handle 40 is provided with a front axle hole 42 throughout the handle 40, the pivoting portion 40c of the handle 40 is provided with a middle axle hole 43 throughout the handle 40. The axle holes 34 of the second pair of pivoting lugs of the first connecting rod 30 are pivotally connected to the front axle hole 42 of the handle 40 through a third rotating axle 73, so the handle 40 is capable of pivoting around the third rotating axle 73 with respect to the first connecting rod 30. The axle holes 24 in the upper portion of the U-shaped movable crushing member 20 away from the crushing plate 22 are pivotally connected to the middle axle hole 43 of the handle 40 though a fourth rotating axle 74, so the handle 40 is further capable of pivoting around the fourth rotating axle 74 with respect to the U-shaped movable crushing member 20. The first locating spacers 84 are sheathed outside the two ends of the fourth rotating axle 74, and are supported between the two sides of the handle 40 and the two side walls 21 of the U-shaped movable crushing member 20, respectively.

In addition, according to the lever principle, as a pivot, the farther the middle axle hole 43 is away from the second end 40b of the handle body 41, and/or the closer the middle axle hole 43 is to the first end 40a of the handle body 41, the greater the lever force as the handle 40 being pressed downward will be.

During the pill crushing process of the pill crusher of the disclosure, the connection between the first rotating axle 71, the second rotating axle 72, the third rotating axle 73, and the fourth rotating axle 74 drives the members connected thereto to pivot around the four rotating axles, respectively. The user forces the second end 40b of the handle 40, the force is transmitted through the deformation of the four-connecting-rod structure, which causes opening and closing between the U-shaped movable crushing member 20 and the U-shaped fixed stopper 50, so the V-shaped crushing cavity will be opened or closed. As the handle 40 is pressed downward, the angle between the first connecting rod 30 and the handle 40 is increased, and the space of the V-shaped crushing cavity is gradually closed; as the handle 40 is lifted upward, the angle between the first connecting rod 30 and the handle 40 is decreased, and the space of the V-shaped crushing cavity is gradually opened.

That is, as the handle 40 rotates, the U-shaped movable crushing member 20 is driven to generate the pressing action applied to the U-shaped fixed stopper 50 around the first rotating axle 71, and the movement route of the handle 40 is converted into the pivot of the U-shaped movable crushing member 20. When the pill required to be crushed is placed in a plastic pill crusher pouch and placed between the U-shaped movable crushing member 20 and the U-shaped fixed stopper 50, it can be crushed and pulverized through the pivoting close of the U-shaped movable crushing member 20 toward the U-shaped fixed stopper 50.

Further, when the pill Y is too large that it cannot be directly crushed by the V-shaped crushing cavity, the pivot between the first connecting rod 30 and the handle 40 is hindered, and the angle between the first connecting rod 30 and the handle 40 is no longer changed, so the U-shaped movable crushing member 20 and the handle 40 form an integrated L-shaped rotating rod to increase the effectiveness of the pill crushing.

On the basis of the embodiment, technical solutions changing in the length or the connected relation of the connecting rod of the four-connecting-rod structure formed by the U-shaped movable crushing member 20, the first connecting rod 30, the handle 40 and the U-shaped fixed stopper 50 are also within the scope of the disclosure.

In the embodiment, the first rotating axle 71 is elastically supported on the upper ends of the long axle holes 53 by the second connecting rod 60 jacked up by the spring 86, but is not limited thereto.

As shown in FIG. 9, the second connecting rod 60 includes two side walls 61 and a connecting plate 62 connected with the two side walls 61. First ends 60a of the two side walls 61 are respectively provided with a pair of long axle holes 63 to form a first pair of pivoting lugs; and second ends 60b thereof are respectively provided with a pair of axle holes 64 to form a second pair of pivoting lugs. Similarly, the first pair of pivoting lugs and the second pair of pivoting lugs may be on a same side wall as shown in FIG. 9 of the embodiment, or may be two pairs of pivoting lugs which are independent of each other. A middle portion of the connecting plate 62 is provided with a mounting hole 65, and a spring 86 is mounted between the mounting hole 65 and the base 10. The axle holes 63 of the first pair of pivoting lugs of the second connecting rod 60 are movably pivotally connected to the long axle holes 53 of lower portions of the two side walls 51 of the U-shaped fixed stopper 50 near the stop plate 52 through the first rotating axle 71, so the first ends 60a of the second connecting rod 60 could move up and down along the long axle holes 53 of the U-shaped fixed stopper 50 following the first rotating axle 71. The axle holes 64 of the second pair of pivoting lugs of the second connecting rod 60 are pivotally connected to the axle holes 55 of the lower portions of the two side walls 51 of the U-shaped fixed stopper 50 away from the stop plate 52 through a fifth rotating axle 75, the second ends 60b of the second connecting rod 60 are fixed, but is not limited thereto. Thereby, the spring 86 will just jacks up the first ends 60a of the second connecting rod 60 pivotally connected with the long axle holes 53, to elastically support the first rotating axle 71 to the top portions of the long axle holes 53. Further, the closer the spring 86 is to the first ends 60a of the second connecting rod 60, the greater the force jacking the first rotating axle 71 is.

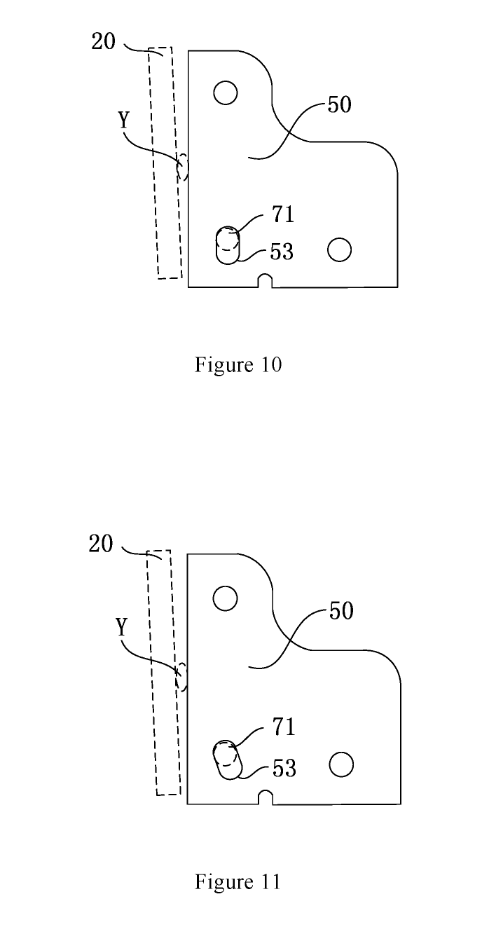

As shown in FIG. 10, in the embodiment, the long axle holes 53 may be elliptic, and the long axes of the ellipses may be perpendicular to the base 10 for the first rotating axle 71 moving up and down therein; the long axle holes 53 may also be circular, oval or rectangular, etc., but are not limited to this.

In another variation, the first rotating axle 71 may also be jacked up directly only by a spring mounted on the base 10 to the upper portions of the long axle holes 53, and the second connecting rod is no longer required. On the basis of the disclosure, technical solutions using other forms to elastically jack up the first rotating axle 71 are also within the scope of the disclosure.

As shown in FIG. 11, in another variation, as shown in FIG. 7, the elliptical long axle holes 53 may be oblique ellipses, but are not limited thereto. Upper ends of the oblique ellipses are close to the stop plate 52, and lower ends thereof are away from the stop plate 52, so as to further control the direction of the first rotating axle 71 along the elliptical long axle holes 53, and further contribute to the U-shaped movable crushing member 20 pressing toward the stop plate 52. On the basis of the disclosure, technical solutions adjusting the size, the direction and the layout of the long axle holes 53 are all within the scope of the disclosure.

In other variations, the long axle holes 53 may be other shapes providing a downward route for the first rotating axle 71, and will not be described here. The long axle hole defined by the disclosure refers to a hole capable of providing a moving space for the rotating axle connected with the movable stop plate at least in a vertical direction or in a direction of the surface of the stop plate. On the basis of the embodiment, technical solutions changing the size, the position and the shape of the long axle holes 53 are all within the scope of the disclosure.

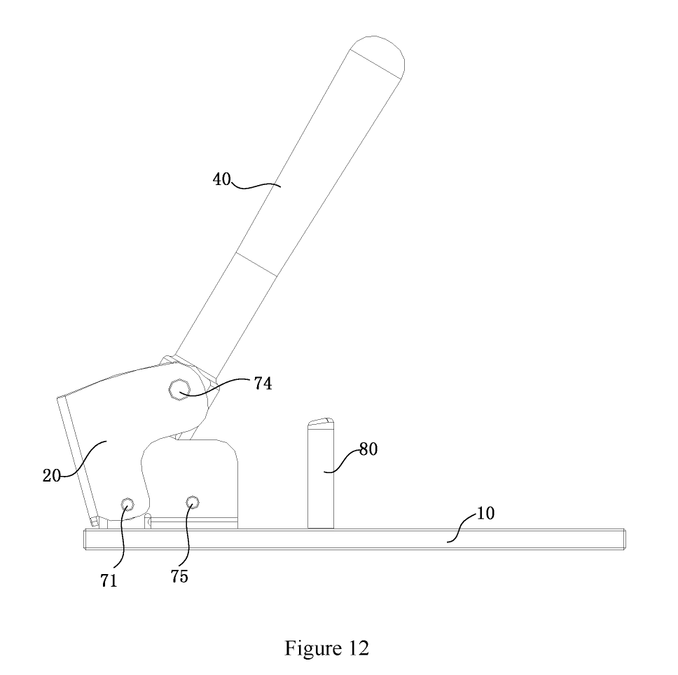

The operating process of the pill crusher according to the first embodiment of the disclosure will be described below mainly with reference to FIGS. 12 to 24. In order to clearly indicate the deformation of the four-connecting-rod structure of the disclosure during the entire pill crushing process, the second rotating axle 72 is defined as a point A of a quadrangle; the third rotating axle 73 is defined as a point B of the quadrangle; the fourth rotating axle 74 is defined as a point C of the quadrangle; the first rotating axle 71 is defined as a point D of the quadrangle; and the fifth rotating axle 75 is defined as a point E, the second end 40b of the handle 40 is G, and the pill is Y.

As shown in FIGS. 12, 13 and 14, the second end 40b of the handle 40 is lifted upward before pulverizing the pill, the handle 40 drives the U-shaped movable crushing member 20 to pivot in a direction away from the U-shaped fixed stopper 50, and then a plastic pill crusher pouch (not shown) filled with pills is placed between the U-shaped movable crushing member 20 and the U-shaped fixed stopper 50. At this time, the cross-section of the four-connecting-rod structure ABCD is an inverted quadrangle. The inverted quadrangle is a special quadrangle that can effectively compress the space of the four-connecting-rod structure, or can form a longer handle in the same space. However, the four-connecting-rod structure forming the inverted quadrangle cannot be realized in two planes, the side walls 21 of the U-shaped movable crushing member 20, the side walls 31 of the first connecting rod 30, the handle 40, and the side walls 51 of the U-shaped fixed stopper 50 of the disclosure are in four different vertical planes, respectively.

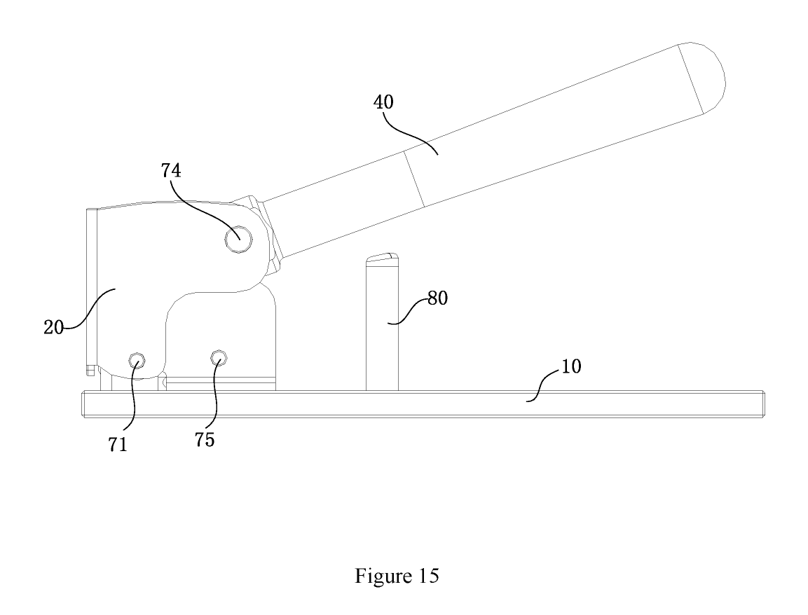

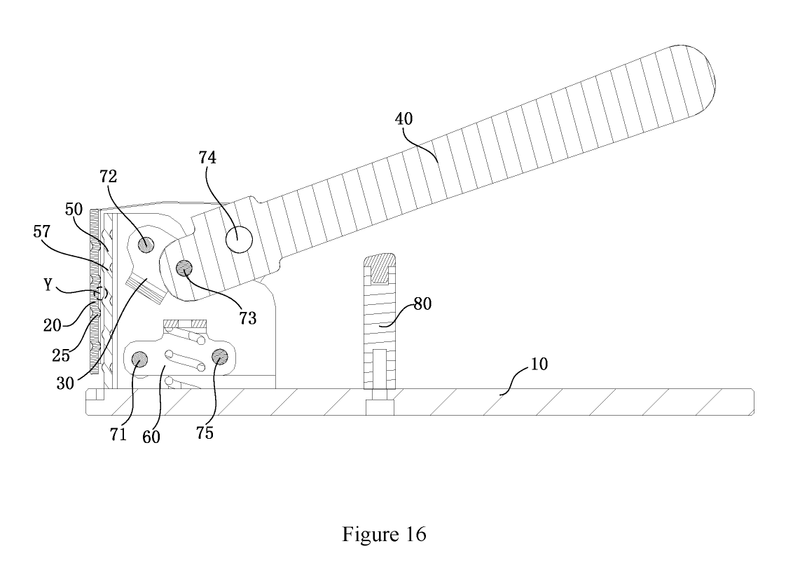

As shown in FIGS. 15 and 16, as the handle 40 is pressed downward, the angle between the first connecting rod 30 and the handle 40 is gradually increased (until the first connecting rod 30 and the handle 40 tend to be in a straight line), and as the handle 40 is further pressed downward, the U-shaped movable crushing member 20 is further pulled toward the U-shaped fixed stopper 50, as the pill is being crushed, the larger the density thereof is, the greater the resistance generated by pill pieces in the crushing area is, and the force for continuing crushing the pill is becoming larger and larger, which makes users feel more laborious when the force is transferred to the handle 40. However, the advantage of the disclosure is that since the fourth rotating axle 74 can be as close as possible to the first end 40a of the handle 40, based on the lever principle, the strength at the forcing end of the handle can be maximally magnified, in the case that the length of the handle 40 remains the same. Moreover, when the forcing end of the handle 40 is further pressed downward, the three pivots of the second rotating axle 72, the third rotating axle 73, and the fourth rotating axle 74 are closer to a straight line, namely the angle formed between the handle 40 and the first connecting rod 30 is closer to 180 degrees, which generates a larger magnification factor of the strength generated by this combination according to the lever principle, and further generates a greater pull force to pull the U-shaped movable crushing member 20 toward the U-shaped fixed stopper 50, to get a better pill crushing effect and a labor-saving feeling.

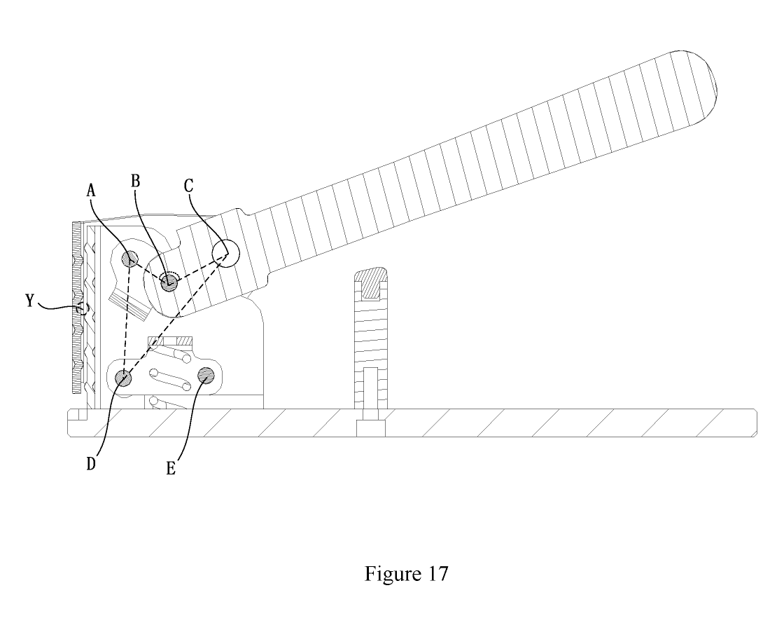

As shown in FIG. 17, at this time, the cross-section of the four-connecting-rod structure ABCD is expanded from the previous inverted quadrangle, the angle between AB and BC continues to grow until AB and BC tend to be in a straight line, and the four-connecting-rod structure ABCD is gradually deformed into a triangle, but is not limited to this.

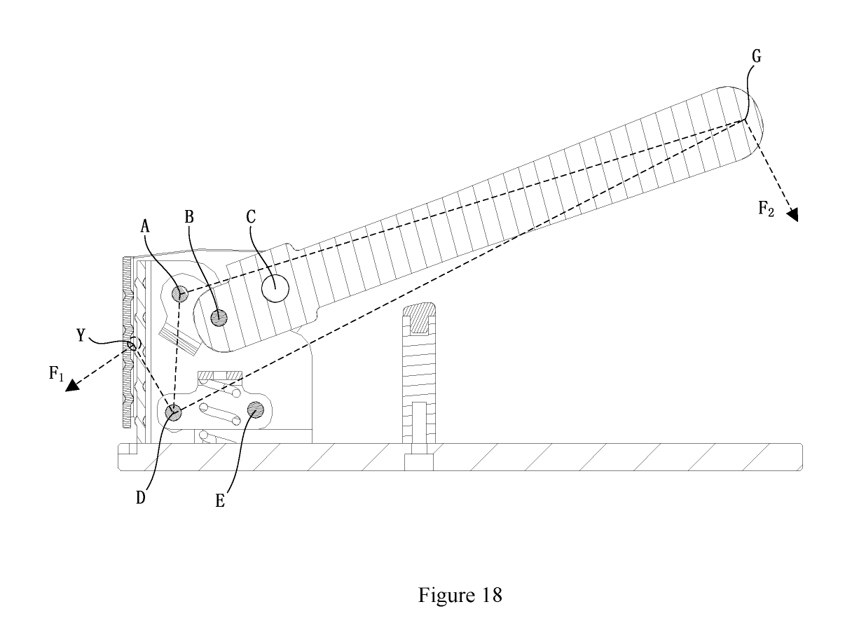

As shown in FIG. 18, in addition to the lever force generated by the deformation of the four-connecting-rod structure ABCD acting on the pill, the disclosure also has an arm extension effect which occurs when the four-connecting-rod structure ABCD cannot continue to deform. When the pill Y is too large or very hard, it cannot be crushed only by the lever force generated by the deformation of the four-connecting-rod structure ABCD, AB and BC cannot continue to pivot, the four-connecting-rod structure ABCD cannot continue to deform (the U-shaped movable crushing member 20, the first connecting rod 30, and the handle 40 are stuck with each other). At this time, AD, AB and BG are integrated to form an L-shaped rotating rod with the point D as a pivot axis. The force direction of the pill Y with respect to the point D is F1, the arm of force of the pill Y is the distance between the pill Y and the point D; and when a force F2 is applied by a user at the point G (the second end 40b of the handle 40), the arm of force is the distance between the point G to the point D, the L-shaped rotating rod has an arm of force far longer than the length of the handle 40, which greatly improves the pill crushing effect. As can be seen from the geometrical relationship between AD, AB, BC, CG and DG in FIG. 18, the arm of force DG is formed by the movable crushing member 20 and the handle 40, the length of the arm DG may greatly exceed the length of the handle 40. So the L-shaped rotating rod can continue to rotate downward with the point D as the pivot, and the pill Y can be crushed on the U-shaped fixed stopper 11 by the U-shaped movable crushing member 20.

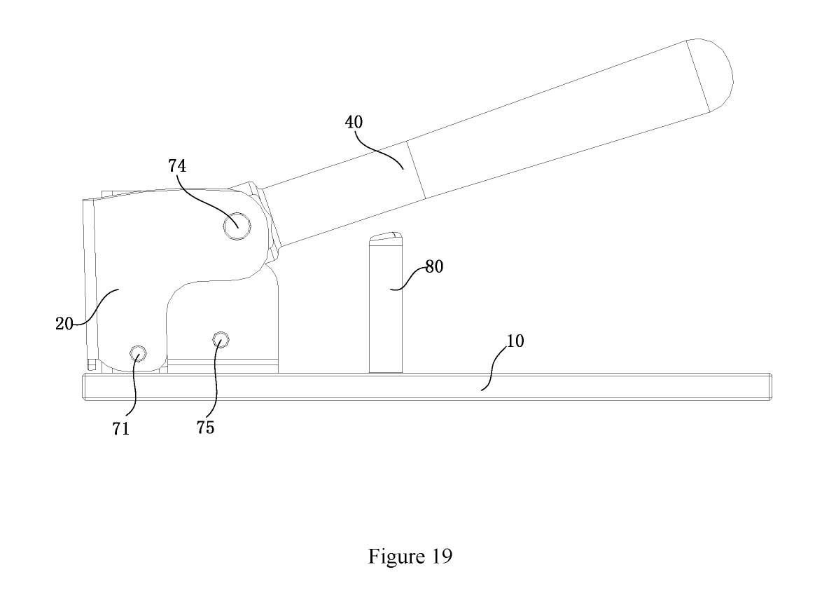

As shown in FIGS. 19, 20, 21 and 22, the disclosure also has a third pill crushing movement mode: the pressure rubbing state, when the above-mentioned two kinds of pill crushing movement modes (the deformation of the four-connecting-rod structure ABCD and the L-shaped rotating rod) of the disclosure cannot crush an overlarge or a super hard pill Y.

At this moment, the four-connecting-rod structure ABCD is stuck and the L-shaped rotating rod cannot continue to be pressed downward, the force (i.e., in the H-direction) applied to the handle 40 by a user will overcome the spring force applied to the first rotating axle 71, to press the first rotating axle 71 from the upper ends of the long axle holes 53 toward the lower ends of the long axle holes 53. During this process, the first rotating axle 71′ under the pressure rubbing state drives the U-shaped movable crushing member 20′ under the pressure rubbing state to move downward (i.e., in the I-direction) with respect to the U-shaped fixed stopper 50 to pressure rub the pill Y, thereby quickly destroying the overall structure of the pill, and improving the pill crushing effect.

Further, the pressure rubbing state in the disclosure is not limited to the fact that neither the deformation of the four-connecting-rod structure ABCD nor the L-shaped rotating rod can complete the crushing, the first rotating axle 71 can be pressed downward more easily by adjusting the jacking force of the spring, so that the pressure rubbing state can be occurred at the same time as the deformation of the four-connecting-rod structure ABCD and the L-shaped rotating rod.

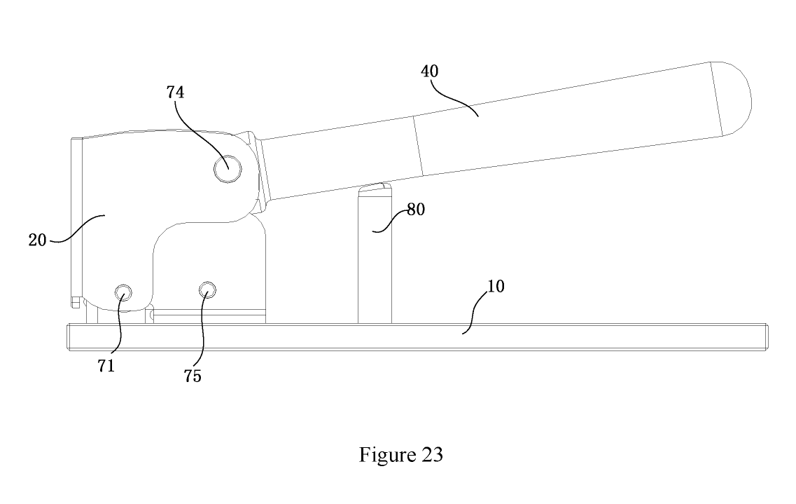

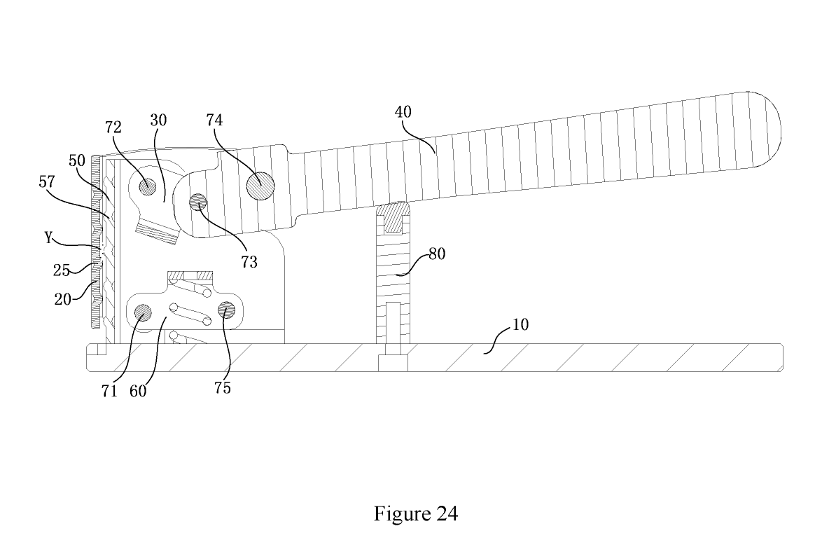

As shown in FIGS. 23 and 24, when the handle 40 is pressed downward to the horizontal state, the first connecting rod 30 is aligned with the handle 40, thereby maximizing the lever dead point reinforcing effect. By combined action or successive action of the three pill crushing modes of the disclosure, the pill crusher of the disclosure can crush large-volume and high-hardness pills, by making full use of the mechanical principle of lever, maximizing and converting the strength at the forcing end of the handle 40 to the crushing area to produce effective pill crushing operation, and thus achieve labor-saving, and reduce potential wrist and elbow damage of users caused by long term use.

Secondly, as the bottom of the crushing area formed by the inverted L-shaped U-shaped movable crushing member 20 and the U-shaped fixed stopper 50 is an open structure, the accumulation of dirt or dust or medicinal powder leaked from the pill crusher pouch due to the accidental break of the pill crusher pouch can be avoided, and meanwhile it is convenient to do maintenance and cleaning for sanitation and hygiene.

Thirdly, as all the mechanical movements of the pill crusher of the disclosure are achieved by the pivoting of the rotating axles rather than sliding structures and the like, it achieves a low-noise operation, and is particularly suitable for quiet medical institutions without disturbing the rest of patients or the working of medical personnel.

Moreover, the structure of the pill crusher of the disclosure can be produced by simple sheet metal processing, e.g., it can be produced by using medical-grade stainless steel as the main material without high cost processing means such as metal casting and machining. Therefore, the pill crusher not only reduces the cost but also completely avoids the possibility of potential pill contamination caused by coating materials of surface treatment process such as coating falling into the accidentally broken pill crusher pouch, and thus enhances product safety.

In summary, the pill crusher of the embodiment has three crushing modes: (1) crushing the pill using the lever force generated by the deformation of the four connecting rods; (2) the four connecting rods forming an integrated L-shaped rotating rod when the deformation thereof cannot crush the pill, the L-shaped rotating rod having an arm of force far longer than the length of the handle 40, which greatly improves the pill crushing effect; (3) destroying the overall structure of the pill by rubbing between the U-shaped movable crushing member 20 and the U-shaped fixed stopper 50, thereby improving the pill crushing effect.

### Second Embodiment

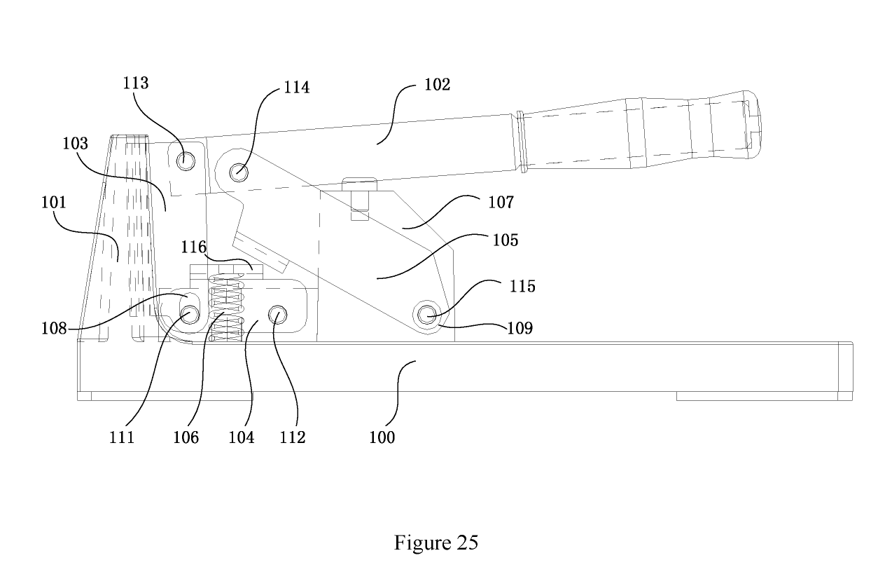

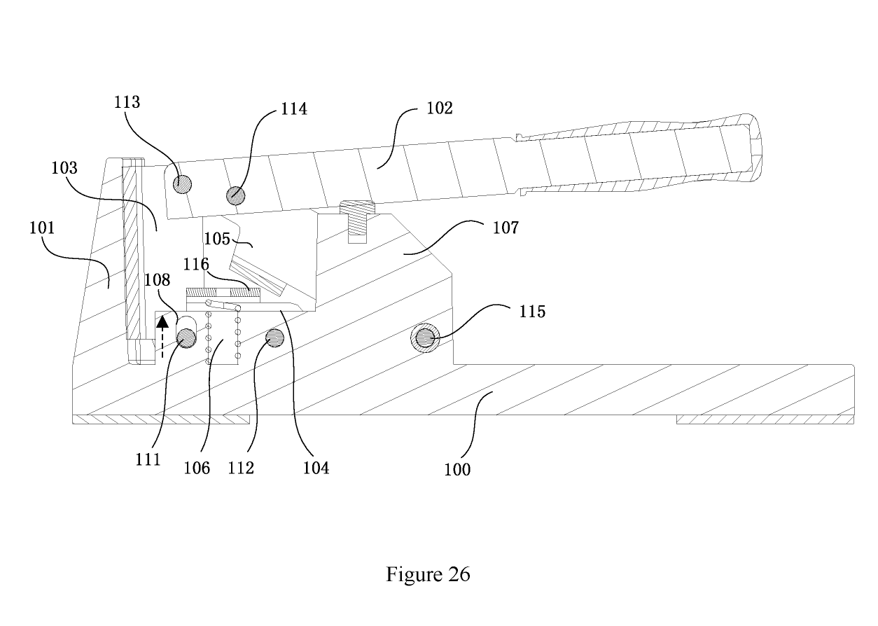

As shown in FIGS. 25 and 26, the disclosure also provides another pill crusher comprising a base 100, a stop plate 101, a handle 102, a movable crushing plate 103, a first connecting rod 105, and a second connecting rod 104.

The base 100 is provided with a pair of long axle holes 108. The long axle holes 108 are elliptical axle holes, and the long axes of the ellipses are perpendicular to the base 100. A stop post 107 for limiting the pressing-down distance of the handle 102 is mounted on the base 100. The stop plate 101 is connected to one end of the base 100.

The movable crushing plate 103 is located at the inner side of the stop plate 101 (i.e., the movable crushing plate 103 is located between the stop plate 101 and the handle 102). The lower end of the movable crushing plate 103 is pivotally connected to the long axle holes 108 of the base 100 through a first rotating axle 111, the first rotating axle 111 is elastically pressed to the lower ends of the long axle holes 108, the movable crushing plate 103 pivots with respect to the stop plate 101 to form a V-shaped crushing cavity capable of being closed by pressing or being opened between the movable crushing plate 103 and the stop plate 101, as the first rotating axle 111 moves from the lower ends to upper ends inside the long axle holes 108, the movable crushing plate 103 rubs upward with respect to the stop plate 101. The long axle holes 108 in this embodiment may be elliptical, and the long axes thereof are perpendicular to the base 100 for the first rotating axle 111 to move up and down therein, but are not limited thereto. The handle 102 has a first end pivotally connected to the upper end of the movable crushing plate 103 through the first pivoting portion 113, and a second pivoting portion 114 behind the first end. The first end of the first connecting rod 105 is pivotally connected to the second pivoting portion 114 of the handle 102, and the second end thereof is pivotally connected to the stop post 107 through the fifth pivoting portion 115. The second connecting rod 104 has a first end pivotally connected to the first rotating axle 111, and a second end pivotally connected to the base 100 through the second pivoting portion 112. A tension spring 106 is arranged between the second connecting rod 104 and the base 100, the tension spring 106 tenses the first rotating axle 111 through the second connecting rod 104 to elastically press the first rotating axle 111 to the lower ends of the long axle holes 108. The base 100, the movable crushing plate 103, the handle 102 and the first connecting rod 105 form a deformable four-connecting-rod structure having four rotating axles, the pill crusher of the embodiment crushes pills by the lever force generated by the deformation of the trapezoidal four-connecting-rod structure.

As the handle 102 is pressed downward, the angle between the movable crushing plate 103 and the handle 102 is decreased, the movable crushing plate 103 is pressed toward the stop plate 101, and the space of the V-shaped crushing cavity is gradually closed. As the handle 102 is lifted upward, the angle between the movable crushing plate 103 and the handle 102 is increased, the movable crushing plate 103 is away from the stop plate 101, and the space of the V-shaped crushing cavity is gradually opened.

Further, a pivot portion 116 is arranged on upper portion of the second connecting rod 104, as the handle 102 is pressed downward, the first connecting rod 105 touches the pivot portion 116, overcomes the tension of the tension spring 106, the second connecting rod 104 pivots upward slightly with the second pivoting portion 112 as the pivot, the first end of the second connecting rod 104 is uplifted, and the movable crushing plate 103 is driven to rub upward with respect to the stop plate 101. In the embodiment, the distance between the pivot portion 116 and the second end of the second connecting rod 104 is less than the distance between the pivot portion 116 and the first end of the second connecting rod 104 for the first connecting rod 105 touching the second connecting rod 104 to achieve the crushing side of the movable crushing plate 103 rubbing upward.

In a preferred embodiment, the stop post 107 is provided with a pivoting hole, the second end of the first connecting rod 105 is pivotally connected to the pivoting hole through a rotating axle, and an elastic sleeve 109 is arranged between the rotating axle and the pivoting hole, in order to achieve buffer and quickly increase the leverage point angle. Thereby, increase the magnification factor of the strength, and enhance the crushing strength and effect.

In a variation, the long axle holes 108 are oblique elliptical axle holes, and the upper ends of the ellipses are closer to the stop plate 101 than the lower ends of the ellipses, so the movable crushing plate 103 is more easily to be pressed to the stop plate 101 when rubbing upward. On the basis of the embodiment, technical solutions adjusting the size, the direction and the layout of the long axle holes 108 are all within the scope of the disclosure.

In another variation, a tension spring is provided between the first rotating axle 111 and the base 100, the tension spring presses the first rotating axle 111 to the lower ends of the long axle holes 108 to achieve the same effect without the second connecting rod. On the basis of the embodiment, the technical solutions of elastically pressing the first rotating axle 111 by other forms are all within the scope of the disclosure.

Unlike the first embodiment, the pill crusher in this embodiment has only two crushing modes: (1) crushing the pill using the lever force produced by the deformation of the four connecting rods; (2) destroying the overall structure of the pill by rubbing between the movable crushing member 103 and the stop plate 101, thereby improving the pill crushing effect.

In summary, the pill crusher of the disclosure uses the V-shaped crushing cavity and the connecting-rod structure, has special ways to crush pills, and is good for users, particularly for users in medical institutions. The pill crusher of the disclosure pulverizes pills in a highly efficient way, greatly buffers the reaction force in crushing pills, reduces the burden of users, and particularly reduces potential wrist and elbow damage of medical personnel due to long-term use.

1. A pill crusher, comprising:
a base;
a stopper, arranged on said base, said stopper provided with a long axle hole;
a U-shaped movable crushing member, sheathed outside said stopper, said U-shaped movable crushing member comprising a crushing plate located at a first side of said stopper and two side walls respectively connected with two sides of said crushing plate, said two side walls pivotally connected with the long axle hole of said stopper through a first rotating axle, said first rotating axle elastically supported on an upper end of said long axle hole, said U-shaped movable crushing member capable of pivoting with respect to said stopper to form a V-shaped crushing cavity capable of being closed by pressing or being opened between said crushing plate and said stopper, and, as said first rotating axle moving from the upper end to a lower end inside said long axle hole, said U-shaped movable crushing member capable of rubbing downward with respect to said stopper;
a first connecting rod, located at a second side of said stopper, said first connecting rod having a first end pivotally connected with said stopper, and a second end;
a handle, having a first end pivotally connected with the second end of said first connecting rod, and a pivoting portion pivotally connected with said two side walls of said U-shaped movable crushing member;
said U-shaped movable crushing member, said first connecting rod, said handle, and said stopper collectively form a deformable four-connecting-rod structure having four rotating axles, as said handle is pressed downward, an angle between said first connecting rod and said handle is increased, and a space of said V-shaped crushing cavity is gradually closed; as said handle is lifted upward, the angle between said first connecting rod and said handle is decreased, and the space of said V-shaped crushing cavity is gradually opened.

2. The pill crusher according to claim 1, further comprising a second connecting rod, having a first end pivotally connected with said first rotating axle, and a second end pivotally connected with said stopper, and a spring is arranged between said second connecting rod and said base, said spring jacks up said first rotating axle through said second connecting rod to elastically jack up said first rotating axle to the upper end of said long axle hole.

3. The pill crusher according to claim 2, wherein said long axle hole is an elliptic axle hole, a long axis of said ellipse is perpendicular to said base; or
said long axle hole is an oblique elliptic axle hole, an upper end of said ellipse is closer to said crushing plate than a lower end of said ellipse.

4. (canceled)

5. The pill crusher according to claim 1, further comprising a spring arranged between said first rotating axle and said base, said spring jacks up said first rotating axle to the upper end of said long axle hole.

6. The pill crusher according to claim 1, wherein as said handle is lifted upward, a cross section of said four-connecting-rod structure is an inverted quadrangle; as said handle is pressed downward, said first connecting rod and said handle tend to be a straight line, the cross section of said four-connecting-rod structure is gradually deformed into a triangle.

7. The pill crusher according to claim 6, wherein when rotation between said first connecting rod and said handle is hindered, said U-shaped movable crushing member and said handle form an integrated L-shaped rotating rod.

8. The pill crusher according to claim 1, wherein said stopper is a U-shaped fixed stopper fixed on said base, and comprises a stop plate arranged with respect to said crushing plate and two side walls respectively connected with two sides of said stop plate;
upper portions of the side walls of said U-shaped fixed stopper are pivotally connected with the first end of said first connecting rod through a second rotating axle;
the second end of said first connecting rod is pivotally connected with the first end of said handle through a third rotating axle; and
upper portions of the side walls of said U-shaped movable crushing member are pivotally connected with the pivoting portion of said handle through a fourth rotating axle.

9. The pill crusher according to claim 8, wherein the two side walls of said U-shaped movable crushing member are sheathed outside the two side walls of said stopper;
the two side walls of said stopper are sheathed outside said first connecting rod and said second connecting rod;
said first connecting rod at least comprises a pair of pivoting lugs located respectively at two sides of the first end of said handle.

10. The pill crusher according to claim 9, further comprising a pair of first locating spacers;
said first locating spacers are sheathed outside two ends of said fourth rotating axle and are supported respectively between the sides of said handle and the two side walls of said U-shaped movable crushing member.

11. The pill crusher according to claim 9, further comprising a pair of second locating spacers (85);
said second locating spacers are sheathed outside two ends of said second rotating axle and are supported respectively between the two sides of said first connecting rod and the two side walls of said stopper.

12. The pill crusher according to claim 9, wherein opposite sides of said crushing plate and said stop plate are respectively provided with any kind of anti-slip stripes, anti-slip patterns, engaged raised stripes, and engaged raised patterns.

13-17. (canceled)

18. The pill crusher according to claim 1, wherein the side walls of said U-shaped movable crushing member are inverted L-shaped.

19. The pill crusher according to claim 8, wherein the side walls of said U-shaped fixed stopper are respectively L-shaped.

20. A pill crusher, comprising:
a base, provided with a pair of long axle holes;
a stop plate, fixed on said base;
a movable crushing plate, a lower end of said movable crushing plate pivotally connected with the long axle holes of said base through a first rotating axle, said first rotating axle elastically pressed on lower ends of said long axle holes, said movable crushing plate capable of pivoting with respect to said stop plate to form a V-shaped crushing cavity capable of being closed by pressing or being opened between said movable crushing plate and said stop plate, and, as said first rotating axle moving from the lower ends to upper ends inside said long axle holes, said movable crushing plate capable of rubbing upward with respect to said stop plate;
a handle, having a first end pivotally connected with an upper end of said movable crushing plate, a second end, and a pivoting portion located between said first end and said second end;
a first connecting rod, a first end thereof pivotally connected with the pivoting portion of said handle, said first connecting rod capable of pivoting around a second end thereof;
said base, said movable crushing plate, said handle, and said first connecting rod form a deformable four-connecting-rod structure having four rotating axles, as said handle is pressed downward, an angle between said movable crushing plate and said handle is decreased, and a space of said V-shaped crushing cavity is gradually closed; as said handle is lifted upward, the angle between said movable crushing plate and said handle is increased, and the space of said V-shaped crushing cavity is gradually opened.

21. The pill crusher according to claim 20, further comprising a second connecting rod, having a first end pivotally connected with said first rotating axle, and a second end pivotally connected with said base, and a tension spring is arranged between said second connecting rod and said base, said tension spring tenses said first rotating axle through said second connecting rod to elastically press said first rotating axle to the lower ends of said long axle holes.

22. The pill crusher according to claim 21 wherein a pivot portion is arranged on an upper portion of said second connecting rod, as said handle is pressed downward, said first connecting rod touches said pivot portion, overcomes tension of said tension spring, uplifts the first end of said second connecting rod, and drives said movable crushing plate to rub upward with respect to said stop plate.

23. (canceled)

24. (canceled)

25. (canceled)

26. The pill crusher according to claim 20, further comprising a tension spring arranged between said first rotating axle and said base, said tension spring presses said first rotating axle to lower ends of said long axle holes.

27. The pill crusher according to claim 20, wherein said base is provided with a stop post for limiting a pressing-down distance of said handle, the second end of said first connecting rod is pivotally connected to said stop post (107).

28. The pill crusher according to claim 27, wherein said stop post is provided with a pivoting hole, the second end of said first connecting rod is pivotally connected with said pivoting hole through a rotating axle, and an elastic sleeve is arranged between said rotating axle and said pivoting hole.

29-34. (canceled)
